(19) United States
(12) Patent Application Publication
(10) Pub. No.: US 2010/0148583 A1
(43) Pub. Date: Jun. 17, 2010

(54) METHOD AND DEVICE FOR PROVIDING BATTERY POLARITY PROTECTION FOR UNINTERRUPTIBLE POWER SUPPLY

(76) Inventor: Sivamani Sudhakar KUKUNURI, Amalapuram (IN)

Correspondence Address: General Electric Company;GE Global Patent Operation, 2 Corporate Drive, Suite 648, Shelton, CT, 06484, US

(21) Appl. No.: 12/336,188

(22) Filed: Dec. 16, 2008

(51) Int. Cl. H02J 9/06; H02J 7/04

(52) U.S. Cl. 307/66; 320/165

(57) ABSTRACT

An apparatus for determining a correct connection of a three-wire battery bank to a UPS is disclosed. The apparatus comprises a sensing printed circuit board receiving a voltage from the battery bank and providing an output of a known value when a correct connection between the battery bank and the UPS is determined, a coil receiving the output from the sensing board and a contactor comprising a plurality of switches, at least one switch for each of the wires, which are closed when the voltage applied to the coil is of a known value.

### FIELD OF THE INVENTION

The present invention relates to the field of power supplies and more particularly to protection of interruptible power supplies.

### BACKGROUND OF THE INVENTION

An Uninterruptible Power Supply (UPS) is used for supplying a clean power to a critical load when a disturbance in a main power supply. Typically, a UPS is connected to a battery bank, so that in the outage of main power it will allow the load to draw power from the battery bank connected to the UPS. Recently, transformer-less UPS topologies are gaining popularity because of their smaller footprint. The smaller footprint of the transformer-less UPS is attributable to the removal of an output transformer, which may occupy 20-30% of the UPS size. This smaller footprint is advantageous for large datacenter applications where space and power requirements are issues.

Because there is no output transformer available in the transformer-less UPS, the DC link voltage in these transformer-less UPS are in the range of 400V-800V. To meet this significantly large DC link voltage, normally banks of batteries ranging from 300V to 480V are connected to the UPS. If these banks of batteries were to be connected with a wrong polarity (i.e., a negative terminal attached to a positive terminal), the UPS will be severely damaged.

FIG. 1A and FIG. 1B represent Illustrative examples of the model LP33_UL series UPS manufactured by the General Electrical Company. Model LP-33_UL series UPS represents a well known transformer-less UPS utilizing a three wire battery bank having twenty-four (24) 12 volt batteries in series. Operation of the model LP-33 is well-known in the art, see for example, www.gedigitalenergy.com, and need not be discussed in detail herein. However, the properties and operating characteristics of the model LP-33 shall be described in sufficient detail to provide a comprehensive understanding of the invention claimed.

With regard to FIG. 1A, the model LP33 UPS 100, includes an input 120, a filter, which includes EMI filter and front end rectifier 135, an inverter and EMI filter 145, a battery booster 165, a battery charger 167 and a battery bank 160. Also shown, is a bypass circuit 125 that receives the input voltage and provides an output to the critical load when a failure in the inverter circuit is detected. Battery bank 160 includes a fast disconnect switch (not shown) and is connected to UPS 100 via battery terminal(s) 166. Although not shown it would be recognized by those skilled in the art that the battery terminal(s) 166 comprise at least one terminal for each line connection,

The voltage applied to the input 120 is provided to an EMI filter+ front end rectifier 135, which converts the input voltage to a direct current (DC) voltage. The DC voltage is then applied to inverter 145 to return the voltage to a voltage similar to that provided at the input (e.g., an alternating current (AC)). In addition, the DC voltage is applied to a battery charger 170 that provides an electrical energy to the batteries within the battery bank 160 to maintain a charge on the batteries.

Battery booster 165 receives voltage from battery bank 160, though battery terminals 166, in case of a failure of the voltage on the input 120, and provides the boosted battery voltage, as the DC voltage, to the inverter 145 to maintain the output voltage to the output 150.

FIG. 1B illustrates an exemplary switching system of a typical three-wire battery cabinet 160 including three terminals. The terminals are represented as positive, negative and neutral. Neutral is the center point of the battery string and is connected to the UPS neutral terminal. Battery bank 160, as discussed, is composed of a plurality of batteries connected in series. In the case of a failure of a voltage on input 120 (FIG. 1A), voltage from the battery bank is provided automatically to the battery booster circuit 165 so that power is drawn from the battery bank 160. A battery fast disconnect switch 175 is always in a closed position irrespective whether of power was being drawn from battery bank 160 or input terminals 120. Hence, when a failure in the input voltage occurs, the output voltage is maintained relatively constant as the voltage is provided by battery bank 160. As would be recognized, output lines 180 of battery bank 160 are applied through battery terminals 166 (FIG. 1A) to UPS 100.

As discussed, one of the potential failures to the illustrated UPS or any other type of UPS is due to the reverse connection of the terminals of the battery system. This reversal of the connections may be due to an installation and/or commissioning error. In addition, improper installation or commissioning may create a potential fire hazard at the customer premises and will also cause damage to the UPS. There are several traditional solutions currently available using diode & transistors to prevent improper installation. For example, J. Falin, “Reverse Current/Battery Protection Circuits,” an application report, Texas Instruments, discloses one method of preventing improper installation wherein the path between the battery and the load are activated only under a correct polarity. However, the disclosed solutions works with the battery system connected to the load via two wires, i.e., positive and negative, and fails to address the situation when a three-wire configuration is involved.

A typical solution for the reverse battery protection of a UPS with three-wire battery system is that of using two series diodes connected across the battery system along with fast acting disconnecting switch 175. An exemplary conventional configuration is shown in FIG. 2. In this case, an alternative current path through the diodes under reverse polarity is provided, which causes damage to the diodes if the tripping of the disconnecting switch fails. The key point in this solution is that the amount of “let-through energy” of the disconnecting switch 175 should be less than the “let-through energy” of the diodes 210, so that in case of an incorrect connection (i.e., reverse polarity) disconnecting switch 175 will cause a disconnection to prevent the voltage from the battery bank 160 to be applied to the UPS.

In this typical solution using diodes, when the disconnection switch 175 malfunctions because of a delayed trip (disconnect) or damage to an internal trip coil, then the diodes will fail and the UPS will not be damaged. As the installed battery ampere-hours (AH) rating is directly proportional to the UPS power rating and required back up time the diode rating must also increase to withstand a huge short circuit current of the battery system when a reverse polarity is occurs as the UPS power rating increases.

Such methods of protecting UPS systems are troublesome as they require destructive protection of the UPS. Destructive protection is non-productive and expensive, as an expensive repair must take place, or the entire device may have to be replaced. Thus, there is a need in the industry of a new method and system for providing reverse protection in UPS with three-wire battery system.

### SUMMARY OF THE INVENTION

As described herein, the embodiments of the present invention overcome one or more of the above or other disadvantages known in the art.

One aspect of the present invention provides an apparatus for determining a correct connection of a three wire Battery bank to a UPS. The apparatus comprises a sensing printed circuit board receiving a voltage from the battery bank and providing an output of a known value when a correct connection between the battery bank and the UPS is determined, a coil receiving the output from the sensing board and a contactor comprising a plurality of switches, at least one switch for each of the wires, which are closed when the voltage applied to the coil is of a known value.

These and other aspects and advantages of the present invention will become apparent from the following detailed description considered n conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and that, unless otherwise indicated, they are merely intended to conceptually illustrate the structures and procedures described herein.

### BRIEF DESCRIPTION OF THE DRAWINGS

In the Figures:

FIG. 1A and 1B illustrate conventional transformer-less UPS and three-wire battery bank.

FIG. 2 illustrates a conventional protection circuit of a UPS.

FIG. 3 illustrates an exemplary reverse polarity protection circuit in accordance with the principles of the invention.

FIG. 4 illustrates a schematic drawing of a reverse polarity protection circuit in accordance with the principles of the invention.

FIG. 5 illustrates a table of different configurations of three-wire battery bank connection to the UPS terminals and the operation of the protection circuit shown in FIGS. 3 and 4.

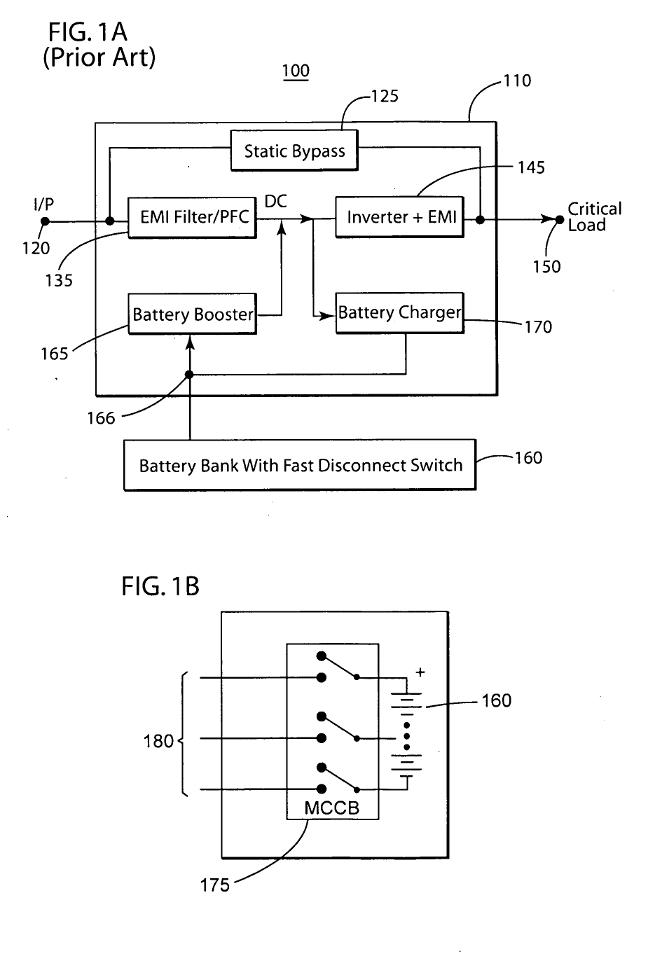

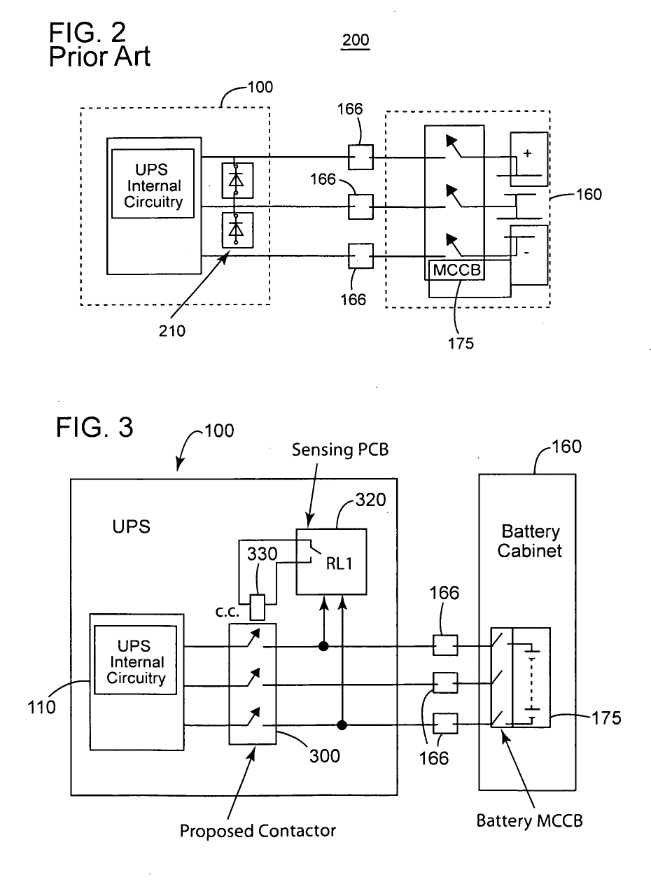

### DETAILED DESCRIPTION OF THE PREFERRED EMBODIMENTS OF THE INVENTION

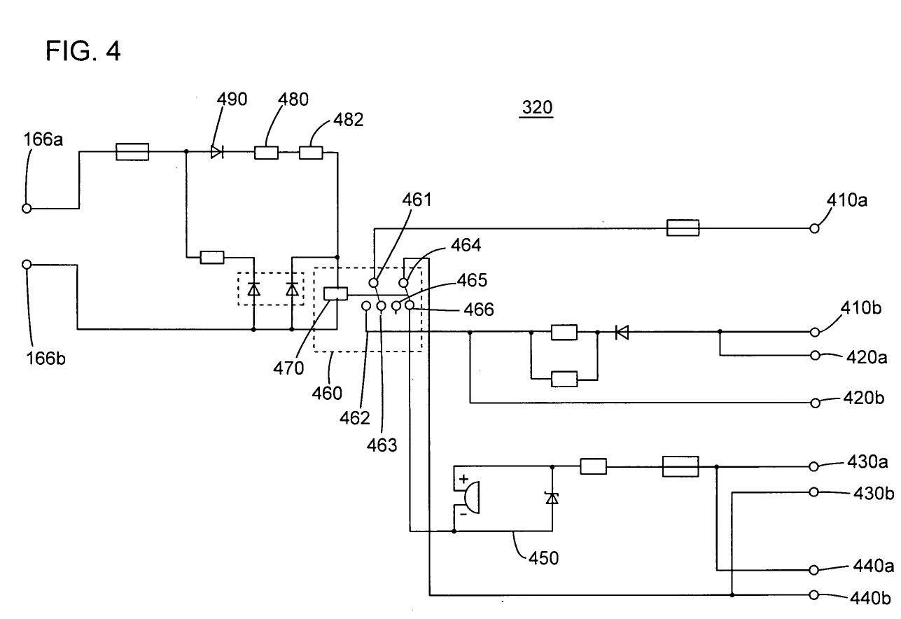

FIG. 3 illustrates a protection circuit for reverse polarity protection including a sensing printed circuit board (PCB) 320 and a three-pole contactor 300, which is used as an interface to connect the UPS 100 and a corresponding battery bank 160. The electronic sensing PCB 320, in this exemplary illustration, uses a diode-resistive-relay network, as will be explained with regard to FIG. 4. The function of sensing circuit 320 is to energize the contactor coil 330 after sensing a correct voltage polarization across the battery terminals 166. After the contactor coil 330 is energized, the contactor coil 330 activates the contactor 300 to establish a path between the UPS 100 and the battery bank 160.

Sensing PCB 320is represented as a simple diode, relay network. However, it would be appreciated that other types of sensing networks have been contemplated and such other types of sensing networks are considered to be within the scope of the invention.

FIG. 4 illustrates a schematic drawing of the sensing PCB 320 shown in FIG. 3. In this illustrated embodiment, terminals 166.a and 166.b sense the polarity of the battery voltage of battery bank 160 (not shown). Terminal 166.a and 166.b represent the positive and negative terminals of the battery bank 160. Terminals 410.a and 410.b represent a nominal (120 VAC) voltage that may be supplied to contactor coil 330 (see FIG. 3). This nominal voltage may be provided by the input voltage provided to the UPS or the output of the UPS. Terminals 410.a and 410.b represent a positive and a neutral terminal of a three-wire electrical connection. Output terminals 420.a and 420.b are connected to contactor coil 330, Terminal 420.a and 410.b are electrically connected to the neutral terminal of a three wire electrical connection. Terminals 430.a and 430.b, represent optional terminal connections for connecting a power supply or providing power to an optional buzzer circuit 450. Relay 460 represents a main relay (RL1) 470 in the sensing PCB and, in this illustrated embodiment has two switching contacts formed by the groups (461, 462, 463 ) and (464, 465, 466). The two switching contacts represent a required coil energization contact and an optional buzzer circuit 450. In this case, no power is provided to the outputs 420.a, 420.b. Normally contacts 461, 463) and (462, 466) are in a Normally ON position and not power is applied to energize the coil 330. However, when relay coil 470 is energized, the relay causes switching contacts 461 to close and be connected to contact 462. Optionally, contact 646 and 465 are electrically connected and buzzer circuit 450 is deactivated.

In this illustrated case, the polarity of battery bank 160 (not shown) is sensed from the positive and negative terminals of the battery terminals. This sensed voltage is applied to the terminals 166.a and 166.b of the sensing PCB 320. The relay coil RL1 470 of the sensing PCB 320 is activated by the voltage sensed across terminals 166.a/166.b. For example in case of the previously referred-to GE model LP33 UPS, the battery voltage between positive and negative terminals 166.a/1 66.b is in the order of 288V (24 batteries * 12V=288V). The resistors R1, R2 480, 482, respectively, shown in the sensing PCB 320, are designed such that there is a drop of 264 volts across these resistors R1, R2. Hence, only about 24V is applied to the RL1 Coil 470. In this illustrated example the relay is selected as a 24V DC Relay. Thus, resistors R1, R2 480, 482, respectively, are selected to provide an appropriate attenuation based on the Relay Coil rating. It would be recognized by those skilled in the art that the value of the resistors 480, 482 and the relay coil 470 may be selected based on one or more desired characteristics, e.g., input voltage, relay coil rating, and/or desired voltage drop. In addition, while two resistors are shown, it would also be within the knowledge of those skilled in the art that the number and size of the resistors may be determined based on a desired power rating or expected current flow.

With the proper connection of the battery polarity, the relay RL1 470 is activated and the contactor coil circuit 330 (see FIG. 3) is energized by the voltage applied to terminal 420.a and 420.b which cause the switches in contactor 300 to close. In addition, the optionally buzzer circuitry is disconnected, as previously discussed.

As illustrated in FIGS. 3 and 4 sensing PCB 320 provides an output across terminals 420.a/420.b that energizes the contactor coil 330 after a proper polarity connection to the battery bank 160 is determined. Proper polarity connection is determined by sensing the voltages from the positive and negative terminals 166.a/166.b of the battery bank 160. The use of only a positive and negative voltage is advantageous as only two sensing signals needed. The contactor selected should be suitably rated accordingly to the desired power requirements.

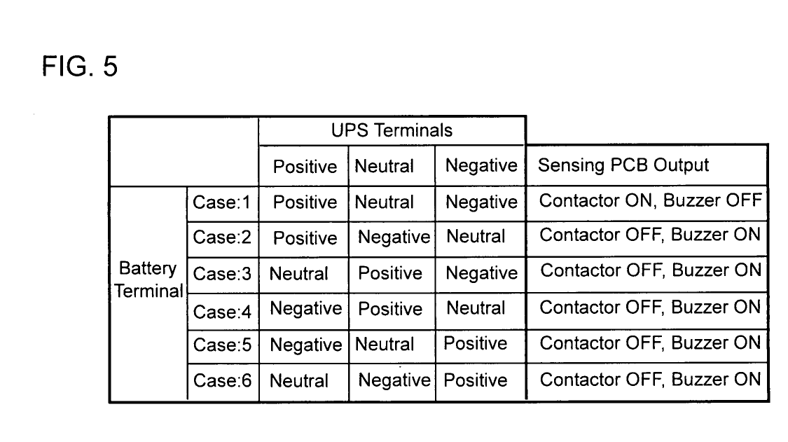

FIG. 5 illustrates representative combinations of connections of UPS terminals. Case 1 represents the only proper polarization connection while cases 2-6 represent improper polarization connections. Referring to case 1, when the battery is connected with a correct polarity with the UPS, the relay 470 is activated by a rated voltage, e.g., 24V, is detected across the coil 470. Once the relay 470 is activated, then the switching contacts 461 and 464 are connected to contacts 462 and 465, respectively. In an initial configuration, the contacts 461 and 464 are connected to contacts 463 and 466 respectively.

With the closing of contacts 461/462 contactor's coil 330 receives power via terminals 410.a/410.b. Also, the closing of switching contacts 464 and 465 causes the, optional, buzzer circuit 450 to be disconnected from the power source via terminal 430.a/430.b.

In cases number 2 and 3 of FIG. 5, the relay coil 470 fails to receive its rated voltage and the relay is not activated. For example with regard to the aforementioned model GE LP33 UPS, the rated voltage is 288V, and in these cases 2and 3, the voltages sensed is in the order of 144V, i.e. half of the total voltage. Hence the relay coil 470 receives a voltage that is insufficient to activate the rely. Accordingly, only optionally buzzer circuit will operate as its circuit is in a normally closed configuration through contacts 464, 466.

In case of 4, 5 and 6 of FIG. 5, diode D1 490 of sensing PCB 320 is reverse biased as the anode potential of the diode is less than the cathode potential. Thus, there is a zero voltage across the relay coil 470.

As previously discussed, a main root cause of a reverse connection of batteries is the mistake done either by installation or service persons during the installation and/or commissioning phase. Occasionally Customers may also perform a reverse connection during battery replacement (as in the case user—replaceable battery systems). Accordingly, in another aspect of the invention, not shown, an annunciation circuitry, e.g., a buzzer indication may be provided in case of mistaken connection. FIG. 5 illustrates that a correct connection is indicated by a green light and an incorrect connection is indicated by a buzzer. Although not shown it would be recognized that a light indicator (LED) may also be provided to provide a visual representation of the electrical connection. For example, a green light may be generated when the connection is correct and a red light when the connection is incorrect. In one aspect of the invention, the switching unit may be alternatively connected such that in one mode a light indication may indicate an incorrect connection and in another mode the light indication may indicate a correct connection responsive to the energized relay. In another aspect, the correct connection indication may be separate from the incorrect connection indication.

While there has been shown, described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An apparatus for determining a correct connection of a three-wire battery bank to a UPS, said apparatus comprising;
a sensing printed circuit board receiving a voltage from said battery bank and providing an output of a known value when a correct connection between said battery bank and said UPS is determined;
a coil receiving said output from said sensing board; and
a contactor comprising a plurality of switches, at least one switch for each of said wires, which are closed when said voltage applied to said coil is of a known value.

2. The apparatus of claim 1, wherein said printed circuit board comprises:
at least one resistor element of a known value in series with said voltage received from said battery bank, said at least one resistor value causing a voltage drop across said at least one resistor value;
a relay, electrically connected to said at least one resistor, receiving a voltage difference between said received voltage and said voltage drop across said at least one resistor; and
at least one switch for providing said known voltage to said coil when said voltage difference provided to said relay is of a predetermined value.

3. The apparatus of claim 2, wherein said at least one switch is a normally-open switch.

4. The apparatus of claim 2, wherein said printed circuit board further comprises:
a buzzer circuit receiving a voltage through a second switch, wherein said relay causes said second switch to disconnect said buzzer circuit when said voltage difference provided to said relay is of said predetermined value.

5. The apparatus of claim 2, wherein printed circuit board further comprises:
a light circuit receiving a voltage through a third switch, wherein said relay causes said third switch to connect said light circuit when said voltage difference provided to said relay is of said predetermined value.

6. The apparatus of claim 2, wherein said known voltage is provided by said UPS.

7. The apparatus of claim 2, wherein said printed circuit board comprises:
a diode in series with said at least one resistor element and said voltage received from said battery bank, said diode being forwarded biased by a correct connection between said battery bank and said UPS is determined.

8. A sensing circuit comprising:
a plurality of terminals receiving a first voltage therebetween;
a diode, at least one resistor and a relay in series with said plurality of terminals, wherein said diode is forward biased when a polarity of said voltage applied to said plurality of terminal is a desired polarity, a known voltage drop occurs across said at least one resistor and said relay is energized when a difference between said received voltage and said voltage drop across said at least one resistor is comparable to a rating of said relay, and
a switching unit responsive to the energized relay provides a nominal voltage to a plurality of output terminals.

9. The sensing circuit of claim 8, wherein said nominal voltage is provided to a second plurality of terminals.

10. The sensing circuit of claim 8, further comprising:
a second switching unit responsive to the energized relay to disconnect an indication circuit.

11. The sensing circuit of claim 10, wherein said indication circuit is at least one selected from the group consisting of: a buzzer circuit and a light circuit.

12. The sensing circuit of claim 8 further comprising:
a third switching unit response to the energized relay to active a second light circuit.
